(19) United States
(12) Patent Application Publication
(10) Pub. No.: US 2024/0072297 A1
(43) Pub. Date: Feb. 29, 2024

(54) ELECTROLYTE COMPOSITION AND LITHIUM BATTERY INCLUDING THE SAME

(71) Applicant: ELECTRONICS AND TELECOMMUNICATIONS RESEARCH INSTITUTE, Daejeon (KR)

(72) Inventors: Jaecheol CHOI, Daejeon (KR); Young-Gi LEE, Daejeon (KR); Ju Young KIM, Daejeon (KR)

(21) Appl. No.: 18/229,287

(22) Filed: Aug. 2, 2023

(30) Foreign Application Priority Data
Aug. 26, 2022 (KR) 10-2022-0107539
Jan. 20, 2023 (KR) 10-2023-0008454

(51) Int. Cl. H01M 10/052; H01M 4/04; H01M 10/0565

(52) U.S. Cl. CPC H01M 10/052; H01M 4/0404; H01M 10/0565; H01M 2300/0085

(57) ABSTRACT

Provided is a lithium battery including a first electrode structure, a second electrode structure spaced apart from the first electrode structure, and an electrolyte between the first electrode structure and the second electrode structure, wherein the electrolyte includes a lithium salt, an organic solvent, and an additive, the additive includes a metal salt compound catalyst, the metal salt compound catalyst activates a polymerization reaction of a cyclic carbonate in the organic solvent at a first temperature, and the first temperature ranges between about 100° C. and about 200° C.

### CROSS-REFERENCE TO RELATED APPLICATIONS

This U.S. non-provisional patent application claims priority under 35 U.S.C. § 119 of Korean Patent Application No. 10-2022-0107539, filed on Aug. 26, 2022, and 10-2023-0008454, filed on Jan. 20, 2023, the entire contents of which are hereby incorporated by reference.

### BACKGROUND

### 1. Field of the Invention

The present disclosure herein relates to a lithium battery, and more particularly, to an electrolyte composition for a lithium battery.

### 2. Description of Related Art

Secondary batteries may include lithium batteries. The lithium batteries have become more broadly applicable lately. For example, the lithium batteries are widely used as a power source for electric vehicles (EV) and energy storage systems (ESS). An increase in the amount of flame retardant may lead to cost and performance issues.

These days, extensive efforts in improving liquid electrolyte/separator systems in lithium batteries are ongoing. However, making the work commercially available is considered to take long due to relatively low ionic conductivity, instability, and large internal resistance. Therefore, research work is continuing on improving the safety of liquid electrolytes without reducing cell performance while maintaining a liquid electrolyte-based lithium battery system.

### SUMMARY

The present disclosure provides an electrolyte composition having improved thermal stability and electrochemical properties, and a lithium battery electrolyte including the same.

The present disclosure also provides a lithium battery having improved electrochemical properties.

An embodiment of the inventive concept provides a lithium battery including a first electrode structure, a second electrode structure spaced apart from the first electrode structure, and an electrolyte between the first electrode structure and the second electrode structure, wherein the electrolyte includes a lithium salt, an organic solvent, and an additive, the additive includes a metal salt compound catalyst, the metal salt compound catalyst activates a polymerization reaction of a cyclic carbonate in the organic solvent at a first temperature, and the first temperature ranges between about 100° C. and about 200° C. In an embodiment of the inventive concept, an electrolyte composition includes a lithium salt, an organic solvent, and an additive, wherein the organic solvent includes a cyclic carbonate, the additive includes a metal salt compound catalyst, the metal salt compound catalyst activates a polymerization reaction of the cyclic carbonate in the organic solvent at a first temperature and causes an increase in viscosity of the electrolyte composition at the first temperature, and the first temperature ranges between about 100° C. and about 200° C.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view showing a lithium battery according to an embodiment of the inventive concept;

FIG. 2 is a view for describing an electrolyte according to embodiments, and is a view enlarging region A of FIG. 1;

FIG. 3 is a view showing a polymerization reaction according to an embodiment of the inventive concept;

FIG. 4 is a graph showing the viscosity and ionic conductivity of each of electrolyte compositions from Comparative Example 1, Experimental Example 1, Experimental Example 2, and Experimental Example 3;

FIG. 5 is a graph showing the initial charge/discharge capacities of lithium batteries prepared in Comparative Example 1 and Example 2; and

FIG. 6 is a graph showing the results obtained by measuring the charge capacity and discharge capacity after solidification of each of lithium batteries prepared in Comparative Example 1 and Example 2.

### DETAILED DESCRIPTION

Preferred embodiments of the present disclosure will be described with reference to the accompanying drawings so as to sufficiently understand constitutions and effects of the inventive concept. However, the present disclosure may be embodied in different forms with various changes, but not limited to the embodiments set forth herein. Rather, these embodiments are provided so that this disclosure will be thorough and complete, and will fully convey the scope of the present disclosure to a person skilled in the art to which the invention pertains.

In this specification, it will be understood that when a component is referred to as being on another component, it can be directly on another component, or an intervening third component may also be present. Also, in the drawings, the thicknesses of the components are exaggerated to effectively describe the technical features. Like reference numerals refer to like elements throughout.

The embodiments described in this description will be explained with reference to the cross-sectional views and/or plan views as ideal example views of the present disclosure. In the drawing, the thicknesses of films and regions are exaggerated for effective descriptions of the technical contents. Thus, regions presented as an example in the drawings have general properties, and shapes of the exemplified areas are used to illustrate a specific shape of a device region. Therefore, this should not be construed as limited to the scope of the present disclosure. Although the terms such as first and second are used to describe various components in various embodiments of this specification, the components should not be limited to these terms. These terms are used only to distinguish one component from another component. Embodiments described and exemplified herein include complementary embodiments thereof.

Terms used herein are not for limiting the inventive concept but for describing the embodiments. As used herein, the singular forms include the plural forms as well, unless the context clearly indicates otherwise. The meaning of “comprises” and/or “comprising” used in the specification does not exclude the presence or addition of one or more other components besides a mentioned component.

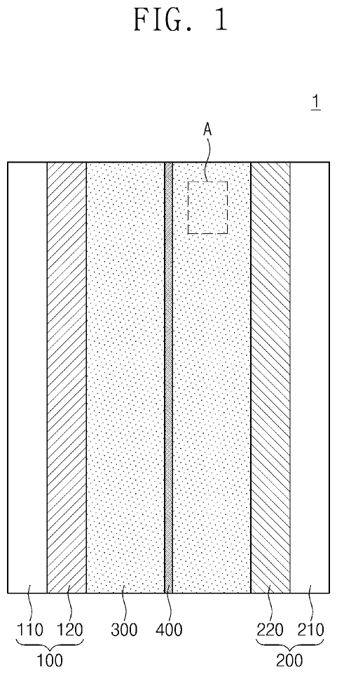

FIG. 1 is a cross-sectional view showing a lithium battery according to an embodiment of the inventive concept.

Referring to FIG. 1, a lithium battery 1 may include a first electrode structure 100, a second electrode structure 200, and an electrolyte 300. The lithium battery 1 may further include a separator 400.

The first electrode structure 100 may include a first current collector 110 and a first electrode layer 120, which are stacked. The first electrode structure 100 may serve as a cathode. The first current collector 110 may include a metal such as aluminum (Al). The first electrode layer 120 may be disposed on the first current collector 110. The first electrode layer 120 may be electrically connected to the first current collector 110. The first electrode layer 120 may include a cathode active material, a conductive material, and a binder. The cathode active material may include, for example, at least one of sulfur, LiCoO2, LiNiO2, LiNixCoyMnzO2 (x, y, and z are each a real number of 0 or greater, and x+y+z=1) (hereinafter referred to as NCM), LiMn2O4, or LiFePO4. For example, the binder may include a fluorine-based polymer such as polyvinylidene fluoride (PVDF). The conductive material may include carbon-containing materials such as conductive amorphous carbon, carbon nanotubes, and/or graphene. The first electrode layer 120 includes a binder and a conductive material, and the first electrode layer 120 may thus have improved mechanical bonding strength and electrical conductivity. For example, the active material, the binder, and the conductive material may be in a weight ratio of 94:3:3 in the first electrode layer 120.

The second electrode structure 200 may be spaced apart from the first electrode structure 100 and may face the first electrode structure 100. The second electrode structure 200 may include a second current collector 210 and a second electrode layer 220. The second electrode structure 200 may serve as an anode. The second electrode layer 220 may be disposed between the second current collector 210 and the first electrode layer 120. The second current collector 210 may include a metal such as copper (Cu). The second electrode layer 220 may be disposed on the second current collector 210. The second electrode layer 220 may be electrically connected to the second current collector 210. The second electrode layer 220 may include an anode active material and a second binder. The anode active material may include a carbon-based material (e.g., natural graphite and/or artificial graphite) or a non-carbon-based material (e.g., silicon, silicon oxide, and/or lithium metal). The second binder may include a cellulosic binder and/or an organic binder. The second binder may include, for example, at least one of cellulose (carboxymethyl cellulose, CMC), styrene-butadiene rubber (SBR), an emulsion, or polyvinylidene fluoride (PVDF).

The separator 400 may be interposed between the first electrode structure 100 and the second electrode structure 200. The separator may be provided between the first electrode layer 120 and the second electrode layer 220, and may be spaced apart from the first electrode layer 120 and the second electrode layer 220. The separator 400 may include a base layer and a coating layer. The base layer may include a polymer. For example, the base layer may include at least one of cellulose or a polyolefin such as polyethylene and/or polypropylene. The separator may include a porous polymer membrane or non-woven fabric. The coating layer may cover the base layer. For example, the coating layer may include an inorganic material such as Al2O3, TiO2, and/or SiO2. As another example, the coating layer may include cellulose (carboxymethyl cellulose, CMC), Styrene-butadiene rubber (SBR), polyvinylidene fluoride (PVDF), and/or a mixture thereof. As another example, the coating layer may include an inorganic material and an organic material.

The electrolyte 300 may be interposed between the first electrode structure 100 and the second electrode structure 200. For example, the electrolyte 300 may be interposed between the first electrode layer 120 and the second electrode layer 220. The electrolyte 300 may fill a gap region between the first electrode layer 120 and the separator 400 and a gap region between the second electrode layer 220 and the separator 400. Ions may move between the first electrode structure 100 and the second electrode structure 200 through the electrolyte 300. The ions may be lithium ions. Hereinafter, the electrolyte according to embodiments will be described in more detail.

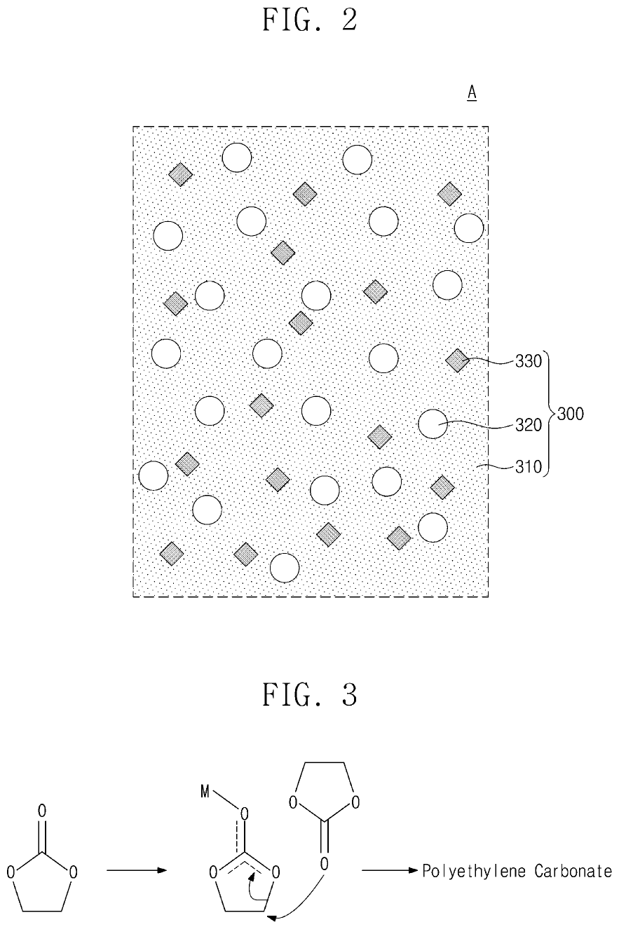

FIG. 2 is a view for describing the electrolyte according to embodiments, and is a view enlarging region A of FIG. 1. Hereinafter, content overlapping the above descriptions will not be given.

Referring to FIG. 2, the electrolyte 300 may include an electrolyte composition. The electrolyte 300 may include a liquid electrolyte. The electrolyte composition may include an organic solvent 310, a lithium salt 320, and an additive 330.

The organic solvent 310 may include a cyclic carbonate. The cyclic carbonate may include, for example, at least one of ethylene carbonate (C₃H₄O₃), propylene carbonate (C₄H₆O₃), dioxolane (C₃H₆O₂), or gamma-butyrolactone (C₄H₆O₂). The organic solvent 310 may further include linear carbonate. The linear carbonate may include, for example, at least one of dimethyl carbonate (C₃H₆O₃), diethyl carbonate (C₅H₁₀O₃), or ethylmethyl carbonate (C₄H₈O₃).

The lithium salt 320 may include, for example, at least one of LiPF6, LiBF4, LiSbF6, LiAsF6, LiClO4, LiN(C2F5SO2)2, LiN(CF3SO2)2, CF3SO3Li, LiC(CF3SO2)3, or LiC4BO8.

The additive 330 may include a metal salt compound catalyst. The metal salt compound catalyst may include metal cations and anions. The cations may be +trivalent or +divalent metal cations. Specifically, the cations may include at least one of Sc(III), Y(III), La(III), As(III), Sb(III), Bi(III), Al(III), Ga(III), In(III), Ti(III), Ce(III), Gd(III), Eu(III), Sn(II), Zn(II), Mn(II), Cu(II), or Mg(II). The anions may be −monovalent anions. Specifically, the anions may include at least one of a halogen-based anion, a sulfuric acid-based anion, a nitric acid-based anion, a phosphoric acid-based anion, or a sulfonic acid-based anion.

FIG. 3 is a view showing a polymerization reaction according to an embodiment of the inventive concept. M in FIG. 3 indicates a cation of the metal salt compound catalyst.

The metal salt compound catalyst may activate a polymerization reaction of a cyclic carbonate in the organic solvent at a first temperature. The first temperature may range between 80° C. and 250° C. More specifically, the first temperature may range between about 100° C. and about 200° C. The polymerization reaction may be a ring-opening polymerization reaction. The electrolyte 300 may have increased viscosity or may be solidified by the polymerization reaction. In an embodiment, the metal salt compound catalyst may activate a chain reaction of ring-opening polymerization of ethylene carbonate to form ethylene carbonate in the form of a polymer (see FIG. 3).

The polymerization reaction of the cyclic carbonate in the organic solvent 310 may not take place at room temperature. Accordingly, the electrolyte 300 may be a liquid at room temperature and a solid or a semi-solid at the first temperature. The electrolyte 300 may have a viscosity of 1 cP to 50 cP at room temperature. The electrolyte 300 may have a viscosity of 10 cP to 1,000,000 cP at the first temperature. More specifically, the electrolyte 300 may have a viscosity of 50 cP to 1,000,000 cP at the first temperature.

As the electrolyte 300 is solidified at the first temperature, movement of lithium ions and electrons may be limited. In addition, rapid damage caused by heat to the first electrode layer 120, the second electrode layer 220, and the separator 400 may be prevented.

For example, the electrolyte 300 may be in a solid state at 100° C. to 200° C., but is not limited thereto. Accordingly, rapid damage to a cell of the lithium battery 1 may be prevented to alleviate or delay ignition and explosion within the cell. Accordingly, the lithium battery 1 may have improved thermal stability. In an embodiment of the inventive concept, the solid state or the semi-solid state may indicate that the electrolyte has a viscosity of about 10 cP to about 1,000,000 cP, more specifically a viscosity of about 50 cP to about 1,000,000 cP.

The additive 330 may be in a weight ratio of about 0.1 wt % to about 20 wt % with respect to the electrolyte. Since the weight ratio of the additive is about 20 wt % or less, the lithium battery 1 including the electrolyte may have improved electrochemical properties. For example, when the weight ratio of the additive 330 is greater than about 20 wt %, mobility of lithium ions between the electrolyte 300 and the first and second electrode layers 120 and 220 may decrease or a side reaction of the electrolyte 300 may take place. A side reaction of the electrolyte 300 may be an undesirable reaction.

As the additive 330 is injected into a pouch cell, the lithium battery 1 may be prepared. For example, the pouch cell electrolyte 330 may be injected and stored at 60° C. for 12 hours or greater, and subjected to a vacuum sealing process after formation and degassing to prepare a lithium battery.

Hereinafter, preparation of electrolyte compositions and lithium batteries will be described with reference to Experimental Examples of an embodiment of the inventive concept.

### 1. Comparative Example 1: Additive without a Metal Salt Compound Catalyst

(Preparation of a first electrode structure) An NCM622 active material was dispersed along with a PVDF binder in an NMP organic solvent to prepare a slurry. In this case, the NCM622 active material, the binder, and the conductive material were in a weight ratio of 94:3:3 for the preparation. The slurry was applied onto an Al current collector and dried to prepare a first electrode structure.

(Preparation of a second electrode structure) Lithium metal and a binder were mixed and dispersed in water to prepare a slurry. The slurry was applied onto a Cu current collector and dried to prepare a second electrode structure.

(Preparation of an electrolyte composition) 1 M lithium salt (LiPF6) was added to a preliminary mixture in which ethylene carbonate (EC) and ethylmethyl carbonate (EMC) were mixed in a weight ratio of 1:1 to prepare a mixture. Additives were not included.

(Preparation of a lithium battery) A 3 mAh class pouch cell was prepared in the form of a coin cell. An electrolyte including the electrolyte composition was injected into the pouch cell.

### 2. Example 1: Additive Including a Metal Salt Compound Catalyst

A scandium trifluoromethanesulfonate (Sc OTf3) metal salt compound catalyst was added in an amount of 1 wt % to the same electrolyte composition as in Comparative Example 1 to prepare an electrolyte composition. A lithium battery was prepared in the same method as in Comparative Example 1, except that the electrolyte composition described above was used as an electrolyte composition.

### 3. Example 2: Additive Including a Metal Salt Compound Catalyst

A scandium trifluoromethanesulfonate (Sc OTf3) metal salt compound catalyst was added in an amount of 3 wt % to the same electrolyte composition as in Comparative Example 1 to prepare an electrolyte composition. A lithium battery was prepared in the same method as in Comparative Example 1, except that the electrolyte composition described above was used as an electrolyte composition.

### 4. Example 3: Additive Including a Metal Salt Compound Catalyst

A scandium trifluoromethanesulfonate (Sc OTf3) metal salt compound catalyst was added in an amount of 5 wt % to the same electrolyte as in Comparative Example 1 to prepare an electrolyte composition. A lithium battery was prepared in the same method as in Comparative Example 1, except that the electrolyte composition described above was used as an electrolyte composition.

Table 1 shows the extent of solidification and ionic conductivity according to the solidification of each of the electrolyte compositions prepared in Comparative Example 1, Example 1, Example 2, and Example 3. Each of the electrolyte compositions was exposed at 120° C. for 5 minutes for solidification.

TABLE 1

| | Comparative | | | | | | | |
|---|---|---|---|---|---|---|---|---|
| | Example 1 | | Example 1 | | Example 2 | | Example 3 | |
| Exposure | Before | After | Before | After | Before | After | Before | After |
| to high | | | | | | | | |
| temperature | | | | | | | | |
| Ionic | 9.89 | 9.93 | 9.74 | 9.07 | 9.50 | 6.51 | 9.27 | Not |
| conductivity | | | | | | | | measurable |
| [mS/cm] | | | | | | | | |
| Extent of | Liquid | Liquid | Liquid | Liquid | Liquid | Semi-solid | Liquid | Solid |
| solidification | | | | | | | | |

Referring to Table 1, it is determined that the ionic conductivity of the lithium battery decreases as the weight ratio of the metal salt compound catalyst to the electrolyte increases, and the ionic conductivity is not measurable when the weight ratio is 5 wt % (Example 3). In addition, it is determined that solidification of the electrolyte composition continues when the weight ratio of the metal salt compound catalyst increases. it is determined that the electrolyte composition turns into a solid when the weight ratio of the metal salt compound catalyst is 5 wt % (Example 3).

Referring to Table 1, it is determined that the ionic conductivity of the lithium battery decreases when the electrolyte composition including the metal salt compound catalyst is exposed to high temperature (120° C.). Accordingly, it is determined that the metal salt compound catalyst added in Experimental Examples 1 to 3 is a temperature-sensitive catalyst. In addition, it is determined that the metal salt compound catalyst limits the movement of ions in the lithium battery at a rising temperature.

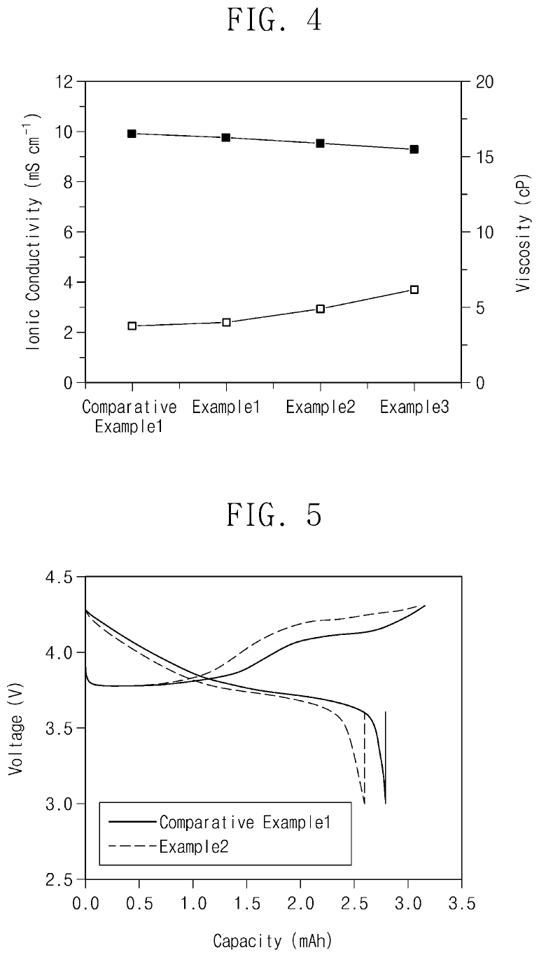

FIG. 4 is a graph showing the viscosity and ionic conductivity of electrolyte compositions of Comparative Example 1, Experimental Example 1, Experimental Example 2, and Experimental Example 3.

The viscosity and ionic conductivity of the electrolyte compositions prepared in Comparative Example 1, Example 1, Example 2 and Example 3 were evaluated. Referring to FIG. 4, compared to Comparative Example 1, it is determined that the viscosity and ionic conductivity remain without significant changes even when the metal salt compound catalyst is included. Therefore, it is determined that the added metal salt compound catalyst does not inhibit ion conduction of lithium ions at room temperature.

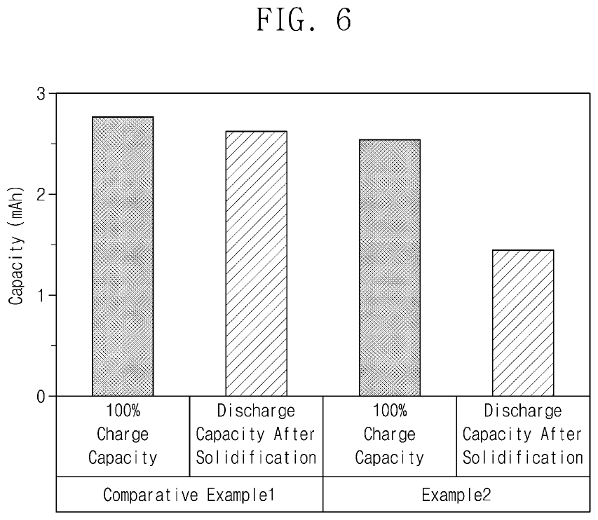

FIG. 5 is a graph showing the initial charge/discharge capacities of lithium batteries prepared in Comparative Example 1 and Example 2.

The charge/discharge performance of each of the lithium batteries prepared in Comparative Example 1 and Example 2 was evaluated. The charge/discharge performance was evaluated in the conditions of 4.3 V charge and 3.0 V discharge cut-off. Referring to FIG. 5, it is determined that the battery of Example 2 has a lower initial discharge capacity than the battery of Comparative Example 1, but has no side reaction. Accordingly, it is determined that the metal salt compound catalyst does not damage the function of the lithium battery at room temperature.

FIG. 6 is a graph showing the results obtained by measuring the charge capacity and discharge capacity after solidification of each of lithium batteries prepared in Comparative Example 1 and Example 2.

Each of the lithium batteries prepared in Comparative Example 1 and Example 2 was charged at a current of 0.3 mA. Thereafter, each lithium cell is exposed at 120° C. for 5 minutes. The lithium cell was discharged at a current of 0.3 mA to measure residual capacity.

Referring to FIG. 6, it is determined that the discharge capacity of the lithium battery (Example 2) including the metal salt compound catalyst is significantly reduced due to solidification of the electrolyte composition at high temperature, compared to the lithium battery (Comparative Example 1) without the catalyst. Accordingly, it is determined that the inclusion of the metal salt compound catalyst may prevent ignition and explosion of the lithium ion battery at high temperature.

Referring to FIGS. 4 to 6, it is determined that the metal salt compound catalyst does not activate a polymerization reaction in an electrolyte at room temperature, and accordingly does not affect the electrochemical properties of the lithium battery 1, and activate the polymerization reaction only when the temperature inside the lithium battery 1 rises. Accordingly, the ignition and explosion in the cell is mitigated and delayed, and thus the lithium battery 1 may have improved thermal stability. In addition, flame retardants may be less added than typical flame retardants, and thus the lithium battery 1 may have improved electrochemical properties.

According to an embodiment of the inventive concept, an electrolyte composition and a lithium battery including the same include a metal salt compound catalyst as an additive. The metal salt compound catalyst activates a polymerization reaction of a cyclic carbonate in an electrolyte at a rising temperature in the lithium battery. The polymerization reaction allows the electrolyte to be solidified, resulting in reduced ionic conductivity of the lithium battery. This prevents an internal short circuit of the lithium battery to avoid ignition and explosion. That is, the lithium battery according to an embodiment of the inventive concept may have improved thermal safety. Accordingly, the lithium battery may have improved electrochemical properties.

While the inventive concept has been described in detail with reference to preferred embodiments thereof, it will be understood that the inventive concept should not be limited to these embodiments but various changes and modifications may be made therein without departing from the spirit and scope of the following claims.

What is claimed is:

1. A lithium battery comprising:
a first electrode structure;
a second electrode structure spaced apart from the first electrode structure; and
an electrolyte between the first electrode structure and the second electrode structure,
wherein the electrolyte includes:
a lithium salt;
an organic solvent; and
an additive,
the additive includes a metal salt compound catalyst,
the metal salt compound catalyst activates a polymerization reaction of a cyclic carbonate in the organic solvent at a first temperature, and
the first temperature ranges between 100° C. and 200° C.

2. The lithium battery of claim 1, wherein the electrolyte is a solid at the first temperature.

3. The lithium battery of claim 1, wherein the additive is in a weight ratio of 0.1 wt % to 20 wt % with respect to the electrolyte.

4. The lithium battery of claim 1, wherein the metal salt compound catalyst comprises metal cations and anions.

5. The lithium battery of claim 3, wherein the cations comprise at least one of Sc(III), Y(III), La(III), As(III), Sb(III), Bi(III), Al(III), Ga(III), In(III), Ti(III), Ce(III), Gd(III), Eu(III), Sn(II), Zn(II), Mn(II), Cu(II), or Mg(II).

6. The lithium battery of claim 3, wherein the anions comprise at least one of a halogen-based anion, a sulfuric acid-based anion, a nitric acid-based anion, a phosphoric acid-based anion, or a sulfonic acid-based anion.

7. The lithium battery of claim 1, wherein the cyclic carbonate comprises at least one of ethylene carbonate, propylene carbonate, dioxolane, or gamma butyrolactone.

8. The lithium battery of claim 1, wherein the organic solvent further comprises a linear carbonate,
the linear carbonate including at least one of dimethyl carbonate, diethyl carbonate, or ethylmethyl carbonate.

9. The lithium battery of claim 1, wherein the first electrode structure comprises a first current collector and a first electrode layer on the first current collector, and
the first electrode layer is provided between the first current collector and the electrolyte.

10. The lithium battery of claim 9, wherein the second electrode structure comprises a second current collector and a second electrode layer on the second current collector, and
the second electrode layer is provided between the second current collector and the electrolyte.

11. The lithium battery of claim 1, further comprising a separator between the first electrode structure and the second electrode structure,
wherein the electrolyte is provided between the first electrode structure and the separator and between the second electrode structure and the separator.

12. An electrolyte composition comprising:
a lithium salt;
an organic solvent; and
an additive,
wherein the organic solvent includes a cyclic carbonate,
the additive includes a metal salt compound catalyst,
the metal salt compound catalyst activates a polymerization reaction of the cyclic carbonate in the organic solvent at a first temperature, and causes an increase in viscosity of the electrolyte composition at the first temperature, and
the first temperature ranges between 100° C. and 200° C.

13. The electrolyte composition of claim 12, wherein the additive is in a weight ratio of 0.1 wt % to 20 wt % with respect to the electrolyte composition.

14. The electrolyte composition of claim 12, wherein the cyclic carbonate comprises at least one of ethylene carbonate, propylene carbonate, dioxolane, or gamma butyrolactone.

15. The electrolyte composition of claim 12, wherein the metal salt compound catalyst comprises metal cations and anions.

16. The electrolyte composition of claim 11, wherein the cations comprise at least one of Sc(III), Y(III), La(III), As(III), Sb(III), Bi(III), Al(III), Ga(III), In(III), Ti(III), Ce(III), Gd(III), Eu(III), Sn(II), Zn(II), Mn(II), Cu(II), or Mg(II).

17. The electrolyte composition of claim 11, wherein the anions comprise at least one of a halogen-based anion, a sulfuric acid-based anion, a nitric acid-based anion, a phosphoric acid-based anion, or a sulfonic acid-based anion.
